(19) United States
(12) Patent Application Publication
(10) Pub. No.: US 2017/0073527 A1
(43) Pub. Date: Mar. 16, 2017

(54) HYDROPHOBING AGENT FOR COATINGS

(71) Applicant: WACKER CHEMIE AG, Munich (DE)

(72) Inventors: Michael STEPP, Ueberackern (AT); Albert HAUSBERGER, Kienberg (DE); Martin SEBALD, Haiming (DE)

(21) Appl. No.: 15/343,246

(22) Filed: Nov. 4, 2016

Related U.S. Application Data
(62) Division of application No. 14/378,147, filed on Aug. 12, 2014.

(30) Foreign Application Priority Data
Feb. 16, 2012 (DE) 102012202389.5

(51) Int. Cl. C09D 5/16; C09D 7/12; C09D 131/04; C09D 5/14

(52) U.S. Cl. CPC C09D 5/1625; C09D 5/14; C09D 7/1233; C09D 131/04; C08K 5/1515

(57) ABSTRACT

Weathering-resistance and hydrophobicity of paints and coatings are enhanced by addition of a composition comprising an organopolysiloxanes bearing pendent aminoalkyl groups and fatty acid ester-based epoxy group-containing compounds.

### CROSS-REFERENCE TO RELATED APPLICATIONS

This application is a Divisional of and claims priority to U.S. Ser. No. 14/378,147, filed Aug. 12, 2014, now pending, which is the U.S. National Phase of PCT Appln. No. PCT/EP2013/052255 filed Feb. 6, 2013, which claims priority to German Application No. 10 2012 202 389.5 filed Feb. 16, 2012, the disclosures of which are incorporated in their entirety by reference herein.

### BACKGROUND OF THE INVENTION

1. Field of the Invention

The invention relates to mixtures of compounds comprising epoxy functions and organosiloxanes comprising amino functions, to their use in weathering-resistant paints and coatings, and to weathering-resistant paints and coatings comprising these mixtures.

2. Description of the Related Art

The protection of industrial built constructions, against moisture and water especially the facades of buildings made from absorbent mineral construction materials such as concrete and masonry made up of bricks or lime sandstone, is one of the principal tasks in architectural preservation.

Water penetration has multivarious deleterious effects:

It soaks the building substance, dissolves inorganic salts and also auxiliaries and additives used in the paints, and transports them to the surface on evaporation, where they may lead in turn to instances of efflorescence and salt-induced chipping and flaking, spotting caused by the stated paint ingredients and by infestation with microorganisms such as fungi, algae, and mosses. Also likely, on account of the reduced thermal insulation, are an adverse effect on the interior climate, and an increased energy consumption.

In recent years, effective architectural paints have been developed which are both hydrophobic and “breathable”, meaning that external rainwater runs off in beads, but moisture located beneath the paint, in the construction material, is able to pass through the paint in the form of water vapor. These paints are based generally on an aqueous polymer dispersion, which as a binder may comprise any organic resins, both of the crosslinkable and of the noncrosslinkable type, but primarily vinyl acetate copolymers and styrene acrylate copolymers, and also straight polyacrylates, and which comprise aqueous emulsions of water-repellent organosiloxane additives as the constituent which gives the paint its essential features.

A criterion for the water repellency effect of a coating or impregnation is the EN1062-3 water permeability rate.

DE 10328636 sets out comprehensively how in practice the moisture protection of conventional paint systems is achieved only after some considerable time. In order to overcome this disadvantage, it proposes the addition to the overall formulation of 0.01-10 wt % of epoxypolysiloxanes modified with oxyalkylene ether groups. The usefulness of epoxy-functional polysiloxanes as a hydrophobizing additive in coating compositions (polymer dispersions) was already described earlier, in DE 69922682: in that case, emulsions of polysiloxanes are employed which carry exclusively epoxy functions. The use of the same products for the water-repellent impregnation of porous and nonporous construction materials is claimed by DE 60108984. The high reactivity of the epoxy functions with the basic substrates is deemed in that case to be responsible for the particular effect.

In both cases, however, the epoxy-functional polysiloxanes are accessible only by way of hydrosilylation reactions, which are expensive owing to the use of unrecoverable platinum catalyst and which, moreover, require unsaturated raw epoxide materials, in some cases highly toxic, and the handling of which entails a high cost and complexity for safety in operation not only in industrial-scale production. In order to prevent toxic, unreacted starting materials from being entrained in the end product, and hence into the environment, a correspondingly costly and inconvenient workup procedure is needed.

DE 3713126 claims combinations of amino-functional polydiorganosiloxanes with silicone resins for the hydrophobizing treatment of aqueous emulsion paints, although it is not evident whether the positive effect derives from the high fraction of expensive silicone resin or from the amino-functional polysiloxane, or from the combination of both additives.

### SUMMARY OF THE INVENTION

Hydrophobing additives for weather resistant architectural paints and coatings contain organopolysiloxanes containing at least one aminoalkyl group and at most 75 mol % silicon-bonded hydroxyl or alkoxy groups, and an epoxy-functional organic compound, preferably an epoxidized naturally occurring substance.

The invention thus provides mixtures of organosiloxanes of the general formula (I)

MₘDₙTₒQₚ (I),

in which

M is a terminal group of the general formula (Ia)

R¹R²R³SiO_{1/2} (Ia),

D is a difunctional group of the general formula (Ib)

R⁴R⁵SiO_{2/2} (Ib),

T is a trifunctional group of the general formula (Ic)

R⁶SiO_{3/2} (Ic),

Q is a unit of the general formula SiO_{4/2},

where R¹, R², R³, R⁴, R⁵ and R⁶ independently of one another stand for a hydrocarbon radical having 1 to 20 C atoms, which may contain heteroatoms, or stand for the hydroxyl radical or alkoxy radicals having 1 to 10 C atoms, where at least one hydrocarbon radical R⁶ contains at least one amine function, and not more than 75% of all of the radicals are hydroxyl or alkoxy radicals,

m is an integer 0-20,

n is an integer 0-1000,

o is an integer 1-30,

p is an integer 0-20, and

m+n+o+p is an integer which is at least 2,

with epoxides of the general formula (II)

(A-B)_{q}C (II)

in which
A independently at each occurrence is a monovalent linear or branched hydrocarbon radical having 1 to 30 C atoms, which may be substituted by heteroatoms, which may be interrupted by heteroatoms, and which may contain one or more epoxy functions,
B independently at each occurrence is a divalent ether, carbonate, or urea function or is an acid, ester, urethane, acid-anhydride, or amide function of a carboxylic acid, thiocarboxylic acid, sulfonic acid, phosphoric acid, or phosphoric acid,
q is a number from 1 to 8,
C is a q-valent linear or branched hydrocarbon radical having one to 30 C atoms, which may contain heteroatoms, and which may contain one or more epoxy functions,

with the proviso that the compound of the general formula (II) comprises at least one epoxy function.

Likewise provided by the invention is the use of the mixtures of organosiloxanes of the general formula (I) with epoxides of the general formula (II) as a hydrophobizing additive for weathering-resistant paints and coatings.

Likewise provided by the invention are weathering-resistant paints and coatings comprising the mixtures of organosiloxanes of the general formula (I) with epoxides of the general formula (II).

It has been surprisingly and unexpectedly found that simple mixtures of commercially available fatty acid esters of the general formula (II) which carry epoxy groups, and amino-functional organosiloxanes of the general formula (I), endow common weathering-resistant paints and coatings, especially emulsion paints, with a strong water repellency effect. In the course of this use, there is no release of unwanted or harmful elimination products or emissions such as solvent vapors, for example. Nor do any color-altering effects such as weathering occur on the fully cured paint films. Another advantage of these mixtures is that both components are common, commercially available and inexpensive classes of product. Furthermore, the epoxy fatty acid esters of the general formula (II) are products which can be produced eco-friendly from renewable raw materials such as plant oils, for example, and which do not have any toxic or environmentally harmful properties.

The emulsion paints are based in general on an aqueous polymer dispersion, which as binder may comprise any organic resins, both of the crosslinkable and of the noncrosslinkable type. The polymers used in this context are preferably polymers or copolymers whose monomers are selected from vinyl esters such as vinyl acetate, vinyl laurate, or vinyl versatate; acrylic esters such as n-butyl acrylate; methacrylic esters such as methyl methacrylate; and monomers such as styrene, isobutene, 1-butene, 1,3-butadiene, ethylene, 1-hexene, vinyl chloride, tetrafluoroethylene, etc., but especially vinyl acetate copolymers with ethylene and/or vinyl chloride, styrene acrylate copolymers, and also straight polyacrylates. Additionally, typically present typically are pigments, more particularly titanium dioxide of the rutile type, fillers such as calcites, natural or precipitated calcium carbonates, aluminum silicates, and mica, and also quartz. Also used, furthermore, are customary auxiliaries and additives such as cellulose derivatives, bentonites, PU thickeners and/or associative thickeners for adjusting rheological behavior, neutralizing agents, wetting and dispersing additives such as, in particular, polycarboxylic acids, preservatives, and defoamers based on mineral oil, silicone oil, or polyethersiloxanes. Additionally present may be silicates such as sodium waterglass and/or silicone resins and/or fluoroalkyl polymer dispersions.

The organosiloxanes of the general formula (I) are preferably commercially available amino(poly)siloxanes. The amine functions here are located in the radicals R⁶ bonded to a tertiary Si unit of the general formula (Ic). The compounds of the general formula (I) are accessible, for example, by reaction of OH-terminated polydiorganosiloxanes with amino-functional trialkoxysilanes, with elimination of alcohol, or by base-catalyzed equilibration of amino-functional (poly)siloxanes with other (poly)siloxanes.

R¹, R², R³, R⁴, R⁵, and R⁶ preferably stand for monovalent linear, branched, cyclic, aromatic, saturated, or unsaturated hydrocarbon radicals and also hydroxyl or alkoxy radicals, having 1 to 10 C atoms, which may be linear, branched, or cyclic, with preferably not more than 50%, more preferably not more than 25%, and most preferably not more than 3% of all the radicals being hydroxyl or alkoxy radicals.

R¹, R², R³, R⁴, and R⁵ in the general formula (I) are preferably a monovalent hydrocarbon radical having 1 to 20 carbon atoms which is unsubstituted or substituted by halogen atoms or by alkoxy, ammonium, or silyl groups, or are hydroxyl radicals, or alkoxy radicals having 1 to 10 C atoms. Particularly preferred are unsubstituted alkyl radicals, cycloalkyl radicals, alkylaryl radicals, arylalkyl radicals, and phenyl radicals. The hydrocarbon radicals R¹, R², R³, R⁴ and R⁵ preferably have 1 to 8 carbon atoms. Particularly preferred are the methyl, ethyl, n-propyl, 2-propyl (isopropyl), 3,3,3-trifluoropropyl, vinyl, 1-n-butyl, 2-methylpropyl (isobutyl), 2-butyl, tert-butyl, n-pentyl, cyclopentyl, cyclohexyl, n-nonyl, n-decyl, n-undecyl, 10-undecenyl, n-dodecyl, isotridecyl, n-tetradecyl, n-hexadecyl, allyl, phenyl, benzyl, p-chlorophenyl, o-(phenyl)phenyl, m-(phenyl)phenyl, p-(phenyl)phenyl, 1-naphthyl, 2-naphthyl, 2-phenylethyl, 1-phenylethyl, 3-phenylpropyl, 1-n-hexyl, 1-n-heptyl, 1-n-octyl, 2,4,4-trimethyl-1-pentyl, 2-ethyl-1-hexyl, 2-methyl-1-pentyl, and also the radicals subsumed by the collective terms isohexyl and isooctyl, especially the methyl, ethyl, propyl, isobutyl, 1-n-hexyl, 1-n-octyl, isohexyl, isooctyl, and phenyl radicals.

Examples of substituted radicals R¹, R², R³, R⁴, and R⁵ are as follows: 3-chloropropyl, chloromethyl, methoxymethyl, ethoxymethyl, 2-trimethylsilylethyl, 2-trimethylsiloxyethyl, 2-trimethoxysilylethyl, 2-dimethylmethoxysilylethyl, 2-dimethoxymethylsilyl, 3-trimethylammoniopropyl, and 3-dimethylbenzylammoniopropyl.

Further examples of substituted radicals R¹, R², R³, R⁴, and R⁵ are C₁-C₁₂ hydrocarbon radicals substituted by radicals of the general formula

—((CR⁷R⁸)ᵣO)ₛ—R⁹ (III)

where r has values from 1 to 6, s can have values from 1 to 100, and R⁷, R⁸, and R⁹ have the definitions of R¹, R², R³, R⁴, and R⁵ with the exception of the hydroxyl radical and of the alkoxy radical, or stand for hydrogen, where also radicals with different units of the general formula (III) may preferably be present in the form of blocks, as for example —CH₂CH₂CH₂—O—(CH₂CH₂O)₆—CH₃, —CH₂CH₂CH₂—O—(CH₂CH(CH₃)O)₈—H, —CH₂CH₂CH₂—O—(CH₂CH₂CH₂CH₂O)₁₀—CH₂CH₂CH₂CH₃, —CH₂CH₂CH₂—O—(CH₂CH₂O)₁₀—(CH₂CH(CH₃)O)₈—CH₂CH₂CH₂CH₃.

Particularly in the presence of oxyethylene radicals or quaternary ammonium radicals, the compound of the general formula (I) and/or the mixture of the two compounds of the general formula (I) and (II) may have self-emulsifying properties, with preferably not more than 60%, more preferably not more than 30%, and most preferably not more than 10% of the radicals in the compounds of the general formula (I) standing for an oxyethylene radicals and/or quaternary ammonium radicals.

More particularly preferred for R¹, R², R³, R⁴, and R⁵ are the methyl, ethyl, propyl, 3,3,3-trifluoropropyl, vinyl, and phenyl radicals, especially the methyl radical.

If R¹, R², R³, R⁴, and R⁵ are alkoxy radicals having 1 to 10 C atoms, the hydrocarbon radicals of the alkoxy radicals preferably have 1 to 4 carbon atoms. With particular preference the hydrocarbon radicals of the alkoxy radicals are methyl, ethyl, n-propyl, 2-propyl(isopropyl), vinyl, 1-n-butyl, 2-methylpropyl(isobutyl), 2-butyl, and tert-butyl radicals.

R⁶ possesses the same definition as the radicals R¹, R², R³, R⁴, and R⁵. Furthermore, R⁶ may be a C₁-C₂₀ hydrocarbon radical, preferably a C₁-C₁₀ hydrocarbon radical, having at least one amine function, preferably —NR¹⁰R¹¹, where R¹⁰ and R¹¹ have the definitions of R¹, R², R³, R⁴, and R⁵ with the exception of the hydroxyl radical and of the alkoxy radical, or stand for hydrogen. Examples of radicals R⁶ are as follows:

aminomethyl, 2-aminoethyl, 3-aminopropyl, 4-aminobutyl, 3-(2-aminoethyl)aminopropyl, (2-aminoethyl)aminomethyl, N-methylaminomethyl, N-ethylaminomethyl, N,N-diethylaminomethyl, N,N-dibutylaminomethyl, N-butylaminomethyl, N-pentylaminomethyl, N-cyclohexylaminomethyl, N-hexylaminomethyl, N-octylaminomethyl, N-(2-ethylhexyl)aminomethyl, N-dodecylaminomethyl, N-hexadecylaminomethyl, 2-N-methylaminoethyl, 3-N-methylaminopropyl, 4-N-methylaminobutyl, N-phenylaminomethyl, N-phenyl-N-methylaminomethyl, N-phenylaminopropyl, N-morpholinomethyl, N-pyrrolidinomethyl, 3-(N-cyclohexyl)aminopropyl, 1-N-imidazolidinopropyl radical.

Further examples of R⁶ are C₁-C₁₂ hydrocarbon radicals substituted by —(CH₂CH₂NH)ₜH where t denotes values from 1 to 10, more preferably 1, 2, or 3.

The amine concentration in the compounds of the general formula (I) is in the range from 0.01 to 10 mol/kg, preferably not more than 5 mol/kg, more preferably not more than 1 mol/kg, most preferably not more than 0.5 mol/kg, and also preferably at least 0.02 mol/kg, more preferably at least 0.05 mol/kg, and most preferably at least 0.1 mol/kg.

The epoxy compounds of the general formula (II) are preferably epoxidized ethers, acids, esters, urethanes, acid anhydrides, or amides, which preferably are available commercially or accessible through simple reactions. The epoxy functions are located preferably in the hydrocarbon radicals A.

The monovalent radical A contains preferably at least one C atom and preferably not more than 26 C atoms, and is of linear or branched construction, and is optionally substituted by heteroatoms or functional groups. Besides the preferred aliphatic units it may also comprise aromatic units, and also bridging heteroatoms, preferably oxygen. The radical carrying epoxy functions is more preferably a linear hydrocarbon radical which comprises at least one epoxy function. In particular, the two carbon atoms of the epoxy function preferably each carry a hydrogen atom. Radical A preferably contains 6 or more, and more particularly 12 or more, carbon atoms. Radical A preferably contains 22 or fewer carbon atoms and not more than on average 2 C═C double bonds. To a minor extent, radical A may also comprise alcoholic OH groups, as products of a hydrolysis of the epoxy function(s), for example.

The unit B is preferably an acid, ester, urethane, acid-anhydride, or amide function of a carboxylic acid, more preferably an acid or ester function, more particularly an ester function of a carboxylic acid.

q preferably stands for 1, 2, or 3, more preferably 3. Insofar as q>1, the units A and B may each be identical or different.

C is an optionally substituted, mono-, di-, tri-, tetra-, penta-, hexa-, hepta- or octavalent linear or branched hydrocarbon radical which optionally comprises heteroatoms and has not more than 30 C atoms, or is a hydrogen atom. C is preferably derived from functional compounds F which are formally capable of reacting with acids, more preferably carboxylic acids, to form ester, amide, urethane, or acid-anhydride groups. These functional compounds F accordingly include compounds having at least one hydroxy function or at least one primary or secondary amine function, examples being alcohols such as methanol, ethanol, 2-butoxyethanol, diethylene glycol monoethyl ether, mono methyl-ethers of polyethylene glycol, diols, such as 1,2-ethanediol or 1,2-propanediol, diethylene glycol, triethylene glycol, polyethylene glycol, dipropylene glycol, polypropylene glycol, dibutylene glycol, triols, such as glycerol, trimethylolethane, or trimethylolpropane, tetrols such as pentaerythritol or ditrimethylolpropane, phenols such as phenol, carboxylic acids such as formic acid, benzoic acid, acetic acid, oleic acid, stearic acid, palmitic acid, linoleic acid, lauric acid, dicarboxylic acids such as oxalic acid, adipic acid, tricarboxylic acids such as citric acid, hydroxycarboxylic acids such as lactic acid, salicylic acid, or tartaric acid, aminocarboxylic acids such as glycine or alanine, and also amines such as n-butylamine or diethylamine, and diamines such as 1,2-diaminoethane (ethylenediamine), 1,3-diaminopropane, 1,4-diaminobutane, 1,5-diaminopentane, 1,6-diaminohexane, triamines such as diethylenetriamine, melamine, and saccharides, more particularly hexoses such as glucose or disaccharides such as sucrose, for example. Depending on whether one or more functional groups of the functional compound F are linked via the units B to the radicals A, the radicals C are monovalent or polyvalent radicals. The radicals C consequently differ from the structure of the functional compound F in that the functions linked to the units B have been replaced by bonds. The monovalent hydrocarbon radicals C comprise preferably aliphatic linear, cyclic or branched, optionally substituted radicals having at least two and more particularly at least one carbon atom(s); the hydrocarbon radical preferably contains not more than 22 carbon atoms and preferably possesses the same definition and preferred definition as the radicals R¹, R², R³, R⁴, and R⁵, with the exception of the hydroxyl radical and of the alkoxy radicals; in addition it preferably comprises substituted hydrocarbon radicals with hydroxyl radicals, with the 2-hydroxyethyl radical, the 2-hydroxypropyl radical, and the 2,3-dihydroxypropyl radical being particularly preferred.

The polyvalent hydrocarbon radicals C are preferably aliphatic, cyclic, or linear or branched, optionally substituted radicals having at least two and more preferably at least one carbon atom(s), the hydrocarbon radical preferably containing not more than 22 carbon atoms.

Examples of hydrocarbon radicals C are as follows:

methyl, ethyl, 2-propyl, 1-propyl, 2-ethylhexyl, cyclohexyl, phenyl, 2-hydroxyethyl, 2,3-dihydroxypropyl, 1,3-dihydroxy-2-propyl, 2-hydroxy-3-propyl, 3-hydroxy-2-propyl, 3-hydroxy-1-propyl, 2-butoxyethyl, 2-aminoethyl, 1,2-ethanediyl, 1,2-propanediyl, 1,3-propanediyl, 1,2-butanediyl, 1,4-butanediyl, 1,5-pentanediyl, 1,6-hexanediyl, 1,8-octanediyl, 1,3-(2-hydroxy)propanediyl, 1,2-(3-hydroxy)propanediyl, 1,2-cyclohexanediyl, 1,4-cyclohexanediyl, 1,4-phenylene, 1,2,3-propanetriyl, and 2-ethoxycarbonylethyl.

A compound of the general formula (II) wherein hydrocarbon radical A comprises aliphatic chains which carry one or more epoxy groups can be obtained by epoxidation of unsaturated aliphatic compounds. Examples of the suitable unsaturated aliphatic compounds are ethylenically unsaturated acids, ethylenically unsaturated esters, and ethylenically unsaturated amides. In general the ethylenically unsaturated bond is not located in the α,β position in relation to a heteroatom in the unsaturated aliphatic compound. It is further preferred for the epoxy group not to be located in the β,γ position in relation to a heteroatom, if the heteroatom is connected via a double bond to the carbon atom. It is further preferred for the ethylenically unsaturated bonds not to be conjugated with one another if the aliphatic chain has a plurality of unsaturated bonds. In general there are more than two, preferably three, saturated carbon atoms located between the heteroatom and the unsaturated bond. Examples of suitable ethylenically unsaturated aliphatic compounds are 4-pentenoic acid, methyl 10-undecenoate, and N,N-dibutyl-6-dodecenamide. Moreover, unsaturated acids, esters, urethanes, and amides of fatty acids are suitable as well. Representative unsaturated fatty acids include lauroleic acid, myristoleic acid, palmitoleic acid, oleic acid, linoleic acid, linolenic acid, ricinoleic acid, gadoleic acid, and erucic acid, and also unsaturated fatty acids (C₂₀ and C₂₂ with polyunsaturated bonds) from herring oil or sardine oil. The epoxy group is preferably not an end group. The epoxy groups in the compound of the general formula (II) comprise primarily internal epoxy groups, as shown in formula (IIa):

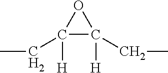

although not necessary, the compound of the general formula (II) customarily comprises more than one aliphatic chain as hydrocarbon radical A, and may comprise a plurality of chains which carry at least one epoxy group. Polyunsaturated fatty acids which are polyepoxidized may also be used, for example, in the form of alkyl esters, in which case the alkyl is, for example, methyl, ethyl, propyl, cyclohexyl, or 2-ethylhexyl.

The average functionality of the compound of the general formula (II) is preferably at least 1, more preferably at least 1.7, and most preferably at least 2.1. The average functionality is preferably lower than 8.

Examples of suitable compounds of the general formula (II) are partially or fully epoxidized unsaturated oils of vegetable or animal origin, or corresponding epoxidized unsaturated fatty acids, which have been wholly or partly esterified with polyalcohols. The compounds of the general formula (II) may comprise, for example, an epoxidized oil and/or natural oils which contain epoxy groups. In the case of fatty chains of natural origin, the ethylenically unsaturated bond is generally seven CH₂ groups distant from a carbonyl group. The remaining double bonds of optionally partly epoxidized fatty acids may remain or may be removed, for example, by hydrogenation and/or by further epoxidization. “Fatty chain” denotes the aliphatic chain of an equivalent fatty acid, of a fatty alcohol, or of a fatty amine. Examples of suitable compounds of the general formula (II) are epoxidized oils, the oil being linseed oil, soybean oil, safflower oil, oiticica oil, caraway oil, rapeseed oil, castor oil, water-free castor oil, cotton seed oil, tung oil, vernonia oil (a natural epoxy-functional oil), tall oil, sunflower oil, peanut oil, olive oil, soya leaf oil, corn oil, fish oil, such as herring oil or sardine oil, for example, and noncyclic terpene oils. The epoxidized oil is preferably epoxidized soybean oil and/or epoxidized linseed oil. Epoxidized compounds of the general formula (II) include diesters, triesters, and oligo esters of polyalcohols such as glycerol, 1,2-propanediol, 1,2-ethanediol, 1,3-propanediol, 1,4-butanediol, polyethylene glycol (e.g., PEG 63, PEG 125, PEG 250, PEG 400), trimethylolpropane, pentaerythritol, and dipentaerythritol, with unsaturated fatty acids. Tall oil fatty acids, and also the fatty acids of the abovementioned unsaturated oils, may be used as the fatty acid. It may be advantageous to use transesterified fatty acids, consisting of fatty acid of these oils with a monoalcohol, if a compound of the general formula (II) having a relatively low functionality is required. Typical monoalcohols are ethanol, tert-butanol, 1-hexanol, and 2-ethylhexanol, or unilaterally endstopped (poly)ethylene glycols. It may also be advantageous to use transesterified fatty acids which consist of fatty acids of these oils with a di-, tri-, or polyalcohol, in which case partial esters may also be employed, in which not all of the OH groups of the polyalcohol are esterified with fatty acids.

A compound of the general formula (II) may also, for example, consist of alcohols which carry an epoxy group and which have been esterified with carboxylic acids which comprise one or more carboxyl groups. Examples of such compounds are triesters of trimellitic acid and 3,4-epoxyhexanol or of epoxidized unsaturated fatty alcohol. As unsaturated fatty alcohols, the alcohol equivalent of a fatty acid may be used. Further compounds of the general formula (II) may be prepared by esterifying unsaturated fatty alcohols with phosphoric acid. This may be done by reacting a fatty alcohol with P₂O₅. Another process involves the transesterification of the fatty alcohol with trimethyl phosphate. Aliphatic compounds with phosphate and/or phosphonate functionality, of the general formula (II), can be obtained, for example, by reacting phosphoric acid and/or a phosphoric acid with a fatty alcohol. The unsaturated bonds in the fatty chains can be subsequently epoxidized in a known way. Yet other suitable compounds of the general formula (II) can be prepared conventionally by means of, for example, the reaction of fatty acids or fatty amines with polyglycidyl compounds, such as triglycidyl isocyanurate or diglycidyl terephthalate, for example, and by subsequent epoxidation of the ethylenically unsaturated bonds. Further compounds of the general formula (II) may be obtained by transesterification of fatty alcohols with dimethyl carbonate or by the reaction of phosgene with fatty alcohols to give fatty carbonates, which are then epoxidized conventionally. Moreover, suitable compounds of the general formula (II) may be obtained by successive reaction of epoxidized fats with CO₂ and unsaturated fatty acids, with subsequent epoxidation. The cyclic carbonates which are obtained in the first step in this case are transesterified in the second step. Suitable compounds of the general formula (II) also include, for example, thioesters of epoxidized fatty acids and polythiols. Other examples of compounds of the general formula (II) include fatty amides, fatty urethanes, or fatty urea derivatives which contain epoxy groups. Amide compounds are advantageous since they may, for example, increase the storage stability of coating blends and of coatings produced from them. Fatty amides may be simply prepared by reaction of unsaturated fatty acids with di-, tri-, or polyamines. Examples of suitable amines include 1,2-diaminoethane, 1,6-diaminohexane, 1,4-cyclohexanedimethylamine, isophoronediamine, 1,4-diaminobutane, and 1,5-diamino-2-ethylaminopentane. The unsaturated fatty amides can then be epoxidized conventionally. A further process for preparing suitable fatty amides embraces the reaction of fatty amines with polyacids, such as terephthalic acid, isophthalic acid, trimellitic acid, or 1,4-cyclohexanedicarboxylic acid, for example. The unsaturated fatty amides are then epoxidized conventionally. Fatty urethanes may be prepared by reaction of unsaturated fatty alcohols with di-, tri-, or polyisocyanates and subsequent epoxidation of the unsaturated fatty chains. Fatty urea compounds may be prepared by reaction of unsaturated fatty amines with di-, tri-, or polyisocyanates and subsequent epoxidation of the fatty chains. A series of polyisocyanates may be used. Fairly suitable among them are hexamethylene diisocyanate (HMDI) or its trimer, isophorone diisocyanate (IPDI) or its trimer, diphenylmethane diisocyanate (MDI), dicyclohexanemethane diisocyanate, toluene 2,4-diisocyanate (TDI), and tetramethylxylene diisocyanate (TMXDI). Modified epoxidized oils or epoxidized alkyd resins may likewise be used. The oils may have been modified, for example, with mono- and/or polyfunctional epoxy-reactive compounds. Examples of such epoxy-reactive compounds are compounds which contain carboxylic acid groups, compounds which contain anhydride groups, compounds which contain amine groups, or bisphenols. Examples of these epoxy-reactive compounds are phthalic acid, isophthalic acid, para-tert-butylbenzoic acid, terephthalic acid, benzoic acid, and adipic acid, phthalic anhydride, hexahydrophthalic anhydride, tetrahydrophthalic anhydride, succinic anhydride, combinations of such anhydrides, 1,4-diaminobutane and 1,6-diaminohexane, and bisphenol A. Another suitable modification involves the urethanization of an oil which contains, for example, one hydroxyl group, such as castor oil, with mono- and diisocyanates, after which the oligomeric oil-urethanes are epoxidized conventionally. Other suitable modified compounds of the general formula (II) are, for example, epoxidized urethanized oils. Suitable products are obtained preferably by single-stage or two-stage transesterification of epoxidized oils with mixtures of polyalcohols and di- or polyalkyl esters of di- or polycarboxylic acids. First, for example, the methyl ester of 4-hexenoic acid may be epoxidized, after which the resulting epoxidized oil is transesterified with an equimolar amount of trimethylolpropane, with the distillative removal of methanol. Thereafter the trimethylolpropane ester of 4,5-epoxyhexanoic acid may be esterified further with dimethylterephthalic acid, with distillative removal of methanol. The result is an epoxidized alkyd resin. In a similar way, an epoxidized oil may, for example, be transesterified with pentaerythritol and simultaneously or subsequently with dimethyl adipate. Mixtures of the compounds of the general formula (II) that are described here may also be used and may be combined in preselected proportions. The preselected proportion will depend on the desired application.

It is possible, moreover, for ethyl 2,3-epoxy-3-phenylpropanoate (ethyl phenylglycidate, EPG) to be employed.

The epoxy oxygen content of the compound of the general formula (II) is generally greater than 1 weight %, preferably greater than 2 weight %. In general the epoxy oxygen content will be less than 20 wt %, in practice less than 15 wt %.

The molar equivalents ratio between the epoxy functions in the compounds of the general formula (II) and the amine functions of the compound of the general formula (I) is preferably between 1 and 50. It is preferably not more than 40, more preferably not more than 30, and most preferably not more than 25, and preferably is at least 1.5, more preferably at least 3, and most preferably at least 5.

These boundary conditions and the concentration of the amine functions in the compounds of the general formula (I), and the concentration of the epoxy functions in the compounds of the general formula (II), produce the preferred mass ratio of the two components employed in the paint.

The concentration of the epoxy functions originating from the compound of the general formula (II) in the weathering-resistant paints and coatings is preferably in the range between 10 and 0.05 mmol/100 g. It is preferably not more than 5 mmol/100 g, more preferably not more than 2 mmol/100 g, and most preferably not more than 1.5 mmol/100 g, and preferably is at least 0.1 mmol/100 g, more preferably at least 0.2 mmol/100 g, and most preferably at least 0.3 mmol/100 g.

Determined from this boundary condition is the amount for addition of the two compounds of the general formulae (I) and (II) to the weathering-resistant paints and coatings, which in accordance with the commercially available compounds of the general formulae (I) and (II) is typically in the range between 0.1 and 5 parts by weight per 100 parts by weight of paint, for both components.

The two components of the general formulae (I) and (II) may be added separately or as a mixture to the weathering-resistant paints and coatings. They are preferably used neat, as a solution in a solvent, or in the form of an aqueous emulsion.

Suitable solvents include all common organic and inorganic solvents or mixtures thereof that do not enter into any unwanted reaction with the compounds of the general formulae (I) and (II), such as aromatic or aliphatic, optionally halogenated hydrocarbons, alcohols, esters, ethers, amides, sulfones, alkoxysilanes, and siloxanes, examples being alkanes, such as pentane, hexane, heptane, isohexane, isooctane, or alkane mixtures, benzene, toluene, xylenes, chlorobenzene, dichloromethane, methanol, ethanol, isopropanol, 1-butanol, ethyl acetate, fatty acid esters or their transesterification products based, for example, on vegetable oils, butyrolactone, tetrahydrofuran, dibutyl ether, methyl tert-butyl ether, N,N-dimethylacetamide, sulfolane, dimethyl sulfoxide, tetraethoxysilane, methyltriethoxysilane, hexamethyldisiloxane, and octamethylcyclotetrasiloxane. Where solutions or emulsions are employed, the active ingredient fraction, i.e., the fraction of the two pure compounds of the general formulae (I) and (II), is preferably at least 1 wt %, more preferably at least 10 wt %, and most preferably at least 30 wt %, and preferably not more than 95 wt %, more preferably not more than 70 wt %, and most preferably not more than 55 wt %, based in each case on 100 parts by weight of the solution or of the emulsion.

In the absence of sufficient self-emulsifiability on the part of the additives of the general formulae (I) and (II), emulsifiers or protective colloids may be added in order to produce emulsions. These are preferably emulsifiers that are known per se. Suitable anionic emulsifiers include, in particular:

1. Alkyl sulfates, particularly those having a chain length of 8 to 18 C atoms, alkyl and alkyl ether sulfates having 8 to 18 C atoms in the hydrophobic radical and 1 to 40 ethylene oxide (EO) and/or propylene oxide (PO) units.

2. Sulfonates, particularly alkylsulfonates having 8 to 18 C atoms, alkylarylsulfonates having 8 to 18 C atoms, taurides, esters and monoesters of sulfosuccinic acid with monohydric alcohols or alkylphenols having 4 to 15 C atoms; these alcohols or alkylphenols may optionally also be ethoxylated with 1 to 40 EO units.

3. Alkali metal salts and ammonium salts of Carboxylic acids having 8 to 20 C atoms in the alkyl, aryl, alkaryl, or aralkyl radical.

4. Partial esters of phosphoric acid and their alkali metal and ammonium salts, particularly alkyl phosphates and alkaryl phosphates having 8 to 20 C atoms in the organic radical, alkyl ether phosphates and alkaryl ether phosphates having 8 to 20 C atoms in the alkyl or alkaryl radical, respectively, and having 1 to 40 EO units.

Suitable nonionic emulsifiers include, in particular:

5. Polyvinyl alcohol, which also has 5 to 50%, preferably 8 to 20%, of vinyl acetate units, with a degree of polymerization of 500 to 3000.

6. Alkyl polyglycol ethers, preferably those having 8 to 40 EO units and having alkyl radicals of 8 to 20 C atoms.

7. Alkylaryl polyglycol ethers, preferably those having 8 to 40 EO units and having 8 to 20 C atoms in the alkyl and aryl radicals.

8. Ethylene oxide/propylene oxide (EO/PO) block copolymers, preferably those having 8 to 40 EO and/or PO units.

9. Adducts of alkylamines having alkyl radicals of 8 to 22 C atoms with ethylene oxide or propylene oxide.

10. Fatty acids having 6 to 24 C atoms.

11. Alkylpolyglycosides of the general formula R*—O-Zᵤ, in which R* is a linear or branched, saturated or unsaturated alkyl radical having on average 8-24 C atoms and Zᵤ is an oligoglycoside radical having on average u=1-10 hexose or pentose units or mixtures thereof.

12. Natural substances and their derivatives, such as lecithin, lanolin, saponins, cellulose; cellulose alkyl ethers and carboxyalkylcelluloses, whose alkyl groups in each case possess up to 4 carbon atoms.

13. Linear organo(poly)siloxane containing polar groups, especially those having alkoxy groups with up to 24 C atoms and/or up to 40 EO and/or PO groups.

Suitable cationic emulsifiers include, in particular:

14. Salts of primary, secondary, and tertiary fatty amines having 8 to 24 C atoms with acetic acid, sulfuric acid, hydrochloric acid, and phosphoric acids.

15. Quaternary alkyl- and alkylbenzeneammonium salts, more particularly those whose alkyl group possesses 6 to 24 C atoms, more particularly the halides, sulfates, phosphates, and acetates.

16. Alkylpyridinium, alkylimidazolinium, and alkyloxazolinium salts, more particularly those whose alkyl chain possesses up to 18 C atoms, especially the halides, sulfates, phosphates, and acetates.

Suitable ampholytic emulsifiers include, in particular:

17. Amino acids with long-chain substitution, such as N-alkyl-di(aminoethyl)glycine or N-alkyl-2-aminopropionic salts.

18. Betaines, such as N-(3-acylamidopropyl)-N,N-dimethylammonium salts with a C₈-C₁₈ acyl radical, and alkylimidazolium betaines.

Preferred as emulsifiers are nonionic emulsifiers, more particularly the alkyl polyglycol ethers listed above under 6., the adducts of alkylamines with ethylene oxide or propylene oxide, listed under 9., the alkylpolyglycosides listed under 11., and the polyvinyl alcohol listed under 5.

Particularly preferred polyvinyl alcohols also contain 5 to 20%, more particularly 10 to 15%, of vinyl acetate units, and preferably have a degree of polymerization of 500 to 3000, more preferably of 1200 to 2000.

The fraction of the emulsifier in the emulsions of the compounds of the general formulae (I) and (II) is preferably 0.1 to 5 wt %, more preferably 0.2 to 2 wt %, and especially 0.3 to 1 wt %. As it is not a hydrophobizing active ingredient, the low level of emulsifier required is an advantage.

Independently of the mode of formulation, it is also possible for mixtures of different compounds of the general formula (I) and/or mixtures of compounds of the general formula (II) to be used.

The two components (I) and (II) possess excellent compatibility, and so can be stored as a mixture before being used in paints. It is also possible to use mixtures of different compounds of the general formula (I) with a compound of the general formula (II), or mixtures of different compounds of the general formula (II) with a compound of the general formula (I), or mixtures of compounds of the general formula (I) with mixtures of compounds of the general formula (II). It is immaterial here whether one or both components or mixtures are premixed and stored with one or more constituents of the weathering-resistant paints and coatings, if this has advantages. Conceivable, for example, are mixtures with emulsifiers, biocides, polymer dispersions, rheological additives, or fillers. If mixtures of the invention are stored in the form of their aqueous emulsion, it is advisable to add biocides in order to increase the storage stability. Additionally, further additives may be added to the emulsions, such as odorants, corrosion inhibitors, buffer substances, and defoamers, for example. The preferred amount of adjuvants is preferably not more than 3 wt %, more preferably not more than 1 wt %, and most preferably not more than 0.5 wt %.

All of the above symbols in the above formulae have their definitions in each case independently of one another. In all formulae the silicon atom is tetravalent.

In the examples which follow, unless indicated otherwise in each case, all quantity and percentage figures are based on weight, all pressures are 0.10 MPa (abs.), and all temperatures are 20° C. All viscosities were measured at 25° C. and 0.10 MPa.

### Preparation of Emulsion Paint A 743

The following are mixed in a commercial high-speed stirrer to produce aqueous architectural coatings, in this order:

TABLE 1
Preparation of emulsion paint A 743

| | |
|---|---|
| 277.7 parts by weight | water |
| 3.2 parts by weight | thickener based on cellulose ether |
| 4.2 parts by weight | dispersant |
| 12.7 parts by weight | fungicide |
| 3.2 parts by weight | defoamer |
| 10.6 parts by weight | film-forming assistant |
| 127.2 parts by weight | titanium dioxide |
| 312.7 parts by weight | nodular filler |
| 42.4 parts by weight | lamellar filler |
| 12.7 parts by weight | matting filler |
| 1.0 parts by weight | pH adjustment with aqueous sodium |
| | hydroxide solution |
| 190.8 parts by weight | an about 50% polymer dispersion |
| | based on vinyl acetate, ethylene, |
| | and vinyl chloride (VINNAPAS ® CEZ |
| | 18 from Wacker Chemie AG) |
| 2.1 parts by weight | rheological additive |
| to give: | |
| 1000 parts by weight | emulsion paint |

Emulsion paint A 743, with the composition as per table 1, is admixed with emulsions in the quantities indicated in table 2, by stirred incorporation.

Employed as compound of the general formula (I) is the following product:

Öl L 652 (WACKER Chemie AG)=amino-functional silicone oil composed of dimethylsiloxy units and N-(2-aminoethyl)aminopropylsiloxy units (T units) and with about 0.13 wt % residual methoxy content, amine number=0.15 meq/g, viscosity˜700 mm²/s

SILRES® BS 1306 (WACKER Chemie AG)=50% aqueous emulsion of Öl L 652 (contains 5 wt % emulsifier)

Employed as compounds of the general formula (II) are the following products:

ELSO=Dehysol® B316 (BASF)=epoxidized linseed oil (6.51 mol/kg epoxy oxygen)

ESBO=Dehysol® D81 (BASF/Emery Oleochemicals)=epoxidized soybean oil (4.58 mol/kg epoxy oxygen)

EPG=Ethyl 3-phenylglycidate (Aldrich) (5.2 mol/kg epoxy oxygen)

EOD=Vikoflex® 4050 (Arkema)=mixture of 32 wt % of the methyl ester and 68 wt % of the 2-ethylhexyl ester of an epoxidized fatty acid ester with about 18 C atoms (3.8 mol/kg epoxy oxygen)

Employed as noninventive compounds for comparative experiments are the following:

PDMS=OH terminal polydimethylsiloxane (chain length about 45) from WACKER Chemie AG

WR 1100 (WACKER Chemie AG)=amino-functional silicone oil composed of dimethylsiloxy units and N-(2-aminoethyl)aminopropylmethylsiloxy units (D units) and with about 0.14 wt % residual methoxy content, amine number=0.15 meq/g, viscosity˜3000 mm²/s

Linseed oil=commercial linseed oil

Preparation of Emulsions from the Compounds of the General Formulae (I) and (II)

The following are mixed in a commercial high-speed stirrer in order to produce aqueous emulsions, in this order:

Emulsion

| | |
|---|---|
| 25.00 parts by weight | emulsifier |
| | (Arlypon IT 5 and Arlypon |
| | IT 10/80 available from |
| | Clariant) |
| 17.50 parts by weight | water |
| 248.80 parts by weight | active ingredient mixture |
| 207.50 parts by weight | water |
| 1.20 parts by weight | preservative |
| | (Konservierer MIT 10 and |
| | Konservierer BIT 10 |
| | available from Thor |
| total: | |
| 500 parts by weight | |

The aqueous emulsion is produced by first mixing 1/10 of the water with the emulsifier. Subsequently, in portions, the mixture of epoxidized oil and amino-functional polydimethylsiloxane is added. Thereafter, very slowly, the water is incorporated by stirring into the stiff phase of the mixture, until the emulsion is highly mobile again. The preservative is incorporated into the mixture in the last portion of water.

Parameters Determined:

On four lime sand bricks (according to DIN 106) in each case, the water permeability rate (w24 in kg/m²h^{0.5} according to DIN EN 1062-3) is ascertained. To verify the color stability (yellowing test), a color measurement is made on the cured paint both before and after UV exposure, using the BYK Gardener Spectro-Guide, in accordance with DIN 6174. The parameter demonstrated in each case is the difference in the b values (Δb).

TABLE 2
Results

| | Additive (amount | | | |
|---|---|---|---|---|
| | added in each case 2 | | | |
| | parts by weight of | | | |
| | emulsion or | | | Water |
| | 1 part by | Water | | contact |
| | weight of active | permeability | | angle after |
| | ingredient (neat) to | rate | Color | QUV-B |
| | 100 parts by weight | w24 | measurement | treatment |
| No. | of paint A743) | [kg/m²√h] | (Δb) | [°] |
| 1* | A743 without additive | 0.97 | 0.61 | 117 |
| 2* | SILRES ® BS 1306 | 0.27 | 0.77 | 140 |
| 3* | Ol L652 (neat) | 0.38 | 0.61 | 132 |
| 4* | ELSO | 0.48 | 0.60 | 38 |
| 5 | ELSO:L652 = 1:4 | 0.17 | 0.88 | 134 |
| 6 | ELSO:L652 = 1:12 | 0.15 (0.16)¹⁾ | — | 135 |
| 7* | Linseed oil:L652 = | 0.32 | −0.07 | 131 |
| | 1:12 | | | |
| 8* | PDMS:L652 = 1:4 | 0.92 | — | — |
| 9 | ESBO:L652 = 1:4 | 0.21 | — | — |
| 10* | ESBO:PDMS = 1:4 | 0.86 | — | — |
| 11* | EOD | 0.93 | — | — |
| 12 | EOD:L652 = 1:4 | 0.17 | — | — |
| 13* | EPG (neat) | 0.90 | 0.89 | 118 |
| 14 | EPG:L652 = 1:4 | 0.17 | 0.95 | 134 |
| 15 | EPG:L652 = 1:12 | 0.20 | 0.82 | 135 |
| 16* | WR 1100 (emulsifier) | 0.30 | 0.78 | 140 |
| 17* | ELSO:WR 1100 = 1:12 | 0.33 | 0.36 | 135 |

¹⁾after 6 months' storage of the emulsion at room temperature
*not inventive

Explanations:

Examples 2, 3, 4, 7, 8, 10, 11, 13, 16, and 17 serve for comparison, in order to illustrate that the reduction in the w24 value comes about only through the inventive combination of epoxide oil and aminosiloxane. Replacing L652 with the amine-free PDMS (10), replacing epoxide with PDMS (8), and replacing ELSO with the analogous epoxide-free linseed oil (7) yield significantly higher W24 values than the corresponding inventive active ingredient mixtures (10→9; 8→5, 9, 12, 14; 7→6). The use of the pure individual substances as well is less effective than the combination of both components (2, 3, 4, 11, 13). Relative to the analogous amine oil WR 1100, which carries the amine functions on D units (difunctional siloxy units), the combination of ELSO with L652 is significantly more effective (17→6), although the two amine oils neat exhibit a smaller difference (16→2). Yellowing in comparison to the paint without additive is not observed in any case. After QUV-B treatment, a distinct bead runoff effect comes about.

What is claimed is:

1. A weather-resistant paint or coating which is an aqueous emulsion, comprising:
a) at least one organic polymer binder;
b) optionally, one or more pigments;
c) optionally, one or more surfactants; and
d) from 0.1 weight percent to 10 weight percent based on the total weight of the aqueous emulsion, of a composition comprising:
at least one organosiloxane of the formula (I)
MₘDₙTₒQₚ (I),
in which
M is a terminal group of the formula (Ia)
R¹R²R³SiO_{1/2} (Ia),
D is a difunctional group of the formula (Ib)
R⁴R⁵SiO_{2/2} (Ib),
T is a trifunctional group of the formula (Ic)
R⁶SiO_{3/2} (Ic),
Q is a unit of the formula SiO_{4/2},
where R¹, R², R³, R⁴, R⁵ and R⁶ independently of one another are hydrocarbon radicals having 1 to 20 C atoms, optionally containing heteroatoms, or are hydroxyl radicals, or alkoxy radicals having 1 to 10 C atoms, where at least one hydrocarbon radical R⁶ contains at least one amine function, and not more than 25% of all of the radicals are hydroxyl or alkoxy radicals,
m is an integer 0-20,
n is an integer 0-1000,
o is an integer 1-30,
p is an integer 0-20, and
m+n+o+p is an integer which is at least 2, and epoxides of the formula (II)
(A-B)_{q}C (II)
in which
A independently at each occurrence is a monovalent linear or branched hydrocarbon radical having 1 to 30 C atoms, optionally substituted by heteroatoms or which is optionally interrupted by heteroatoms, and which optionally contains one or more epoxy functions,
B independently at each occurrence is a divalent ether, carbonate, or urea function or is an acid, ester, urethane, acid-anhydride, or amide function of a carboxylic acid, thiocarboxylic acid, sulfonic acid, phosphoric acid, or phosphoric acid,
q is a number from 1 to 8,
C is a q-valent linear or branched hydrocarbon radical having one to 30 C atoms which optionally contains heteroatoms, and which optionally contains one or more epoxy functions,
with the proviso that the compound of the formula (II) comprises at least one epoxy function wherein the ratio of molar equivalents of epoxy functions in the epoxides of formula (II) to amine functions in the organosiloxanes of formula (I) is from 1 to 50.

2. The weather-resistant paint or coating of claim 1, wherein R¹, R², R³, R⁴, and R⁵ are selected from the group consisting of methyl, ethyl, propyl, 3,3,3-trifluoropropyl, vinyl, phenyl, hydroxyl, methoxy, ethoxy, and mixtures thereof.

3. The weather-resistant paint or coating of claim 1, wherein the amine function on R⁶ has the formula —NR¹⁰R¹¹, where R¹⁰ and R¹¹ independently have the definitions of R¹, R², R³, R⁴, and R⁵ with the exception of the hydroxyl radical and alkoxy radicals, or are hydrogen.

4. The weather-resistant paint or coating of claim 1, wherein R⁶ has the formula —CH₂—CH₂—CH₂—NH—CH₂—CH₂—NH₂.

5. The weather-resistant paint or coating of claim 1, wherein the amine concentration in the compounds of the formula (I) is in the range from 0.01 to 10 mol/kg.

6. The weather-resistant paint or coating of claim 1, wherein epoxy functions are located in the hydrocarbon radicals A.

7. The weather-resistant paint or coating of claim 1, wherein the unit B is an acid, ester, urethane, acid-anhydride, or amide function of a carboxylic acid.

8. The weather-resistant paint or coating of claim 1, wherein C is derived from functional compounds F which are formally capable of reacting with acids to form ester, amide, urethane, or acid-anhydride groups.

9. The weather-resistant paint or coating of claim 1, wherein the compounds of the formula (II) comprise epoxidized unsaturated oils of vegetable or animal origin or from epoxidized unsaturated fatty acids of vegetable or animal origin which have been wholly or partly esterified with polyalcohols.

10. The weather-resistant paint or coating of claim 1, wherein the epoxy oxygen content of the compound(s) of the formula (II) is greater than 1 weight % and less than 20 wt %.

11. The weather-resistant paint or coating of claim 14, wherein the molar equivalents ratio between the epoxy functions in the compounds of the formula (II) and the amine functions of the compounds of the formula (I) is between 3 and 25.

12. The weather-resistant paint or coating of claim 1, wherein the organosiloxane (I) is a linear amine-functional organosiloxane oil.

13. The weather-resistant paint or coating of claim 1, wherein substituents R¹ through R⁵ are selected from the group consisting of methyl, ethyl, n-propyl, 2-propyl, vinyl, 1-n-butyl, 2-methylpropyl, 2-butyl, t-butyl, 3,3,3-trifluoropropyl, hydroxy, and alkoxy.

14. The weather-resistant paint or coating of claim 1, wherein substituents R¹ through R⁵ are selected from the group consisting of methyl, hydroxy, and alkoxy.

15. The weather-resistant paint or coating of claim 1, wherein the organosiloxane of the formula (I) contains hydroxyl and or alkoxy groups.

16. The weather-resistant paint or coating of claim 1, wherein the organosiloxane (I) contains alkoxy and/or hydroxy groups, in an amount of up to 3% by weight based on the total weight of organopolysiloxane (I).

17. The weather-resistant paint or coating of claim 1, which is free of surfactants.

18. The weather-resistant paint or coating of claim 1, further comprising at least one additive selected from the group consisting of fungicides, defoamers, film-forming assistants, and rheological additives.

19. The weather-resistant paint or coating of claim 1, comprising at least one pigment.

20. A method of increasing the weatherability of a building facade, comprising applying an architectural paint or coating which is a paint or coating of claim 1.
